(19) United States
(12) Patent Application Publication
(10) Pub. No.: US 2017/0108096 A1
(43) Pub. Date: Apr. 20, 2017

(54) APPARATUS AND METHOD FOR ADJUSTING THE STROKE LENGTH OF A MOVABLE MEMBER

(71) Applicant: VAMCO INTERNATIONAL, INC., Pittsburgh, PA (US)

(72) Inventors: VAUGHN H. MARTIN, MARS, PA (US); BRYAN P. GENTILE, LONGBOAT KEY, FL (US); JOSEPH P. GENTILE, LONGBOAT KEY, FL (US)

(21) Appl. No.: 15/292,353

(22) Filed: Oct. 13, 2016

Related U.S. Application Data
(60) Provisional application No. 62/241,260, filed on Oct. 14, 2015.

(51) Int. Cl. F16H 21/20; B30B 1/26

(52) U.S. Cl. CPC F16H 21/20; B30B 1/263

(57) ABSTRACT

An apparatus and a method are provided for adjusting the stroke length of a reciprocating member such that the stroke length can be infinitely varied between a minimum and a maximum stroke length. A pair of crankshafts are each connected to an eccentric and configured to operate with a phase offset such that the stroke length can be varied by adjusting the phase offset.

### CROSS-REFERENCE TO RELATED APPLICATION

This application claims the benefit under 35 U.S.C. §119(e) of the earlier filing date of U.S. Provisional Patent Application No. 62/241,260 filed on Oct. 14, 2015, the disclosure of which is incorporated by reference herein.

### FIELD OF INVENTION

The invention generally relates to an apparatus for adjusting the stroke length of a reciprocating member. More particularly, the invention relates to a mechanical press having an apparatus for adjusting the stroke length of the movable member of the press.

### BACKGROUND OF THE INVENTION

A press machine is a tool used to work a material such as metal by changing its shape and internal structure to form pieces.

A punch press is a type of press machine used for forming and/or cutting material. The punch press holds one or more die sets consisting of a set of (male) punches and (female) dies that, when pressed together, can form a hole in a workpiece or can deform the workpiece in some desired manner. The punches and the dies can be removable with the punch being temporarily attached to the end of a movable member during the punching process.

A press drive assembly enables linear motion in a vertical direction of the movable member. In many conventional mechanical presses, the press drive assembly includes a motor and a single crankshaft arranged to convert rotary-oscillatory motion into the linear motion of the movable member. It is often desirable to adjust the stroke length of the movable member. Examples of adjusting the stroke length of a movable member are found in U.S. Pat. Nos. 6,606,941; 6,647,869; 6,654,661; 6,711,995; 7,024,913; 2005/0145117 and 2006/0144258 the disclosures of which are incorporated by reference herein.

### BRIEF DESCRIPTION OF THE DRAWINGS

For the invention to be clearly understood and readily practiced, the invention will be described in conjunction with the following FIG., wherein like reference characters designate the same or similar elements, which FIG. is incorporated into and constitute a part of the specification, wherein:

FIG. 1 is a perspective view of a press machine according to an embodiment of the invention.

FIG. 2 is a view of the detail of the crankshafts and eccentrics in a portion of the press machine according to an embodiment of the invention.

FIG. 3 is a planar view of a press machine according to an embodiment of the invention.

FIG. 4 is a schematic view of a portion of the press machine according to an embodiment of the invention.

### DETAILED DESCRIPTION OF THE PREFERRED EMBODIMENTS

It is to be understood that the FIG. and descriptions of the invention have been simplified to illustrate elements that are relevant for a clear understanding of the invention, while eliminating, for purposes of clarity, other elements that may be well known. Those of ordinary skill in the art will recognize that, such as, for example, all of the components of the reactor coolant pumps other than as shown in the FIG. have not been described in detail herein for the purpose of simplifying the specification of the patent application.

For purposes of the description hereinafter, the terms “upper”, “lower”, “vertical”, “horizontal”, “axial”, “top”, “bottom”, and derivatives thereof shall relate to the invention, as it is oriented in the drawing FIGS. However, it is to be understood that the invention may assume various alternative configurations except where expressly specified to the contrary. It is also to be understood that the specific elements illustrated in the FIG. and described in the following specification are simply exemplary embodiments of the invention. Therefore, specific dimensions, orientations and other physical characteristics related to the embodiments disclosed herein are not to be considered limiting.

The detailed description will be provided hereinbelow with reference to the attached drawings. In the drawings, like reference characters designate corresponding parts throughout the views.

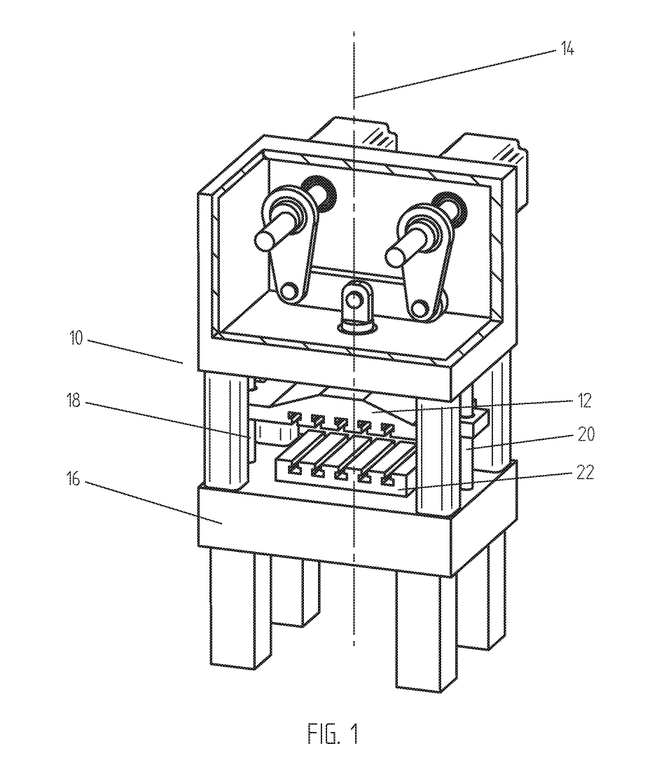

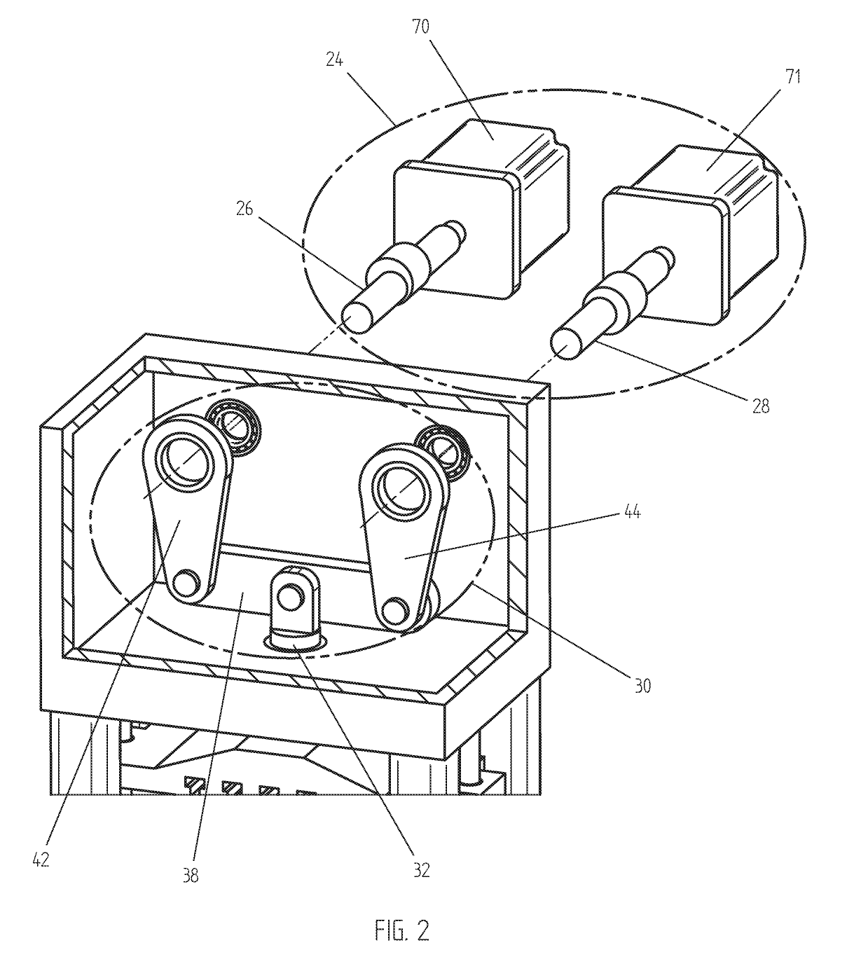

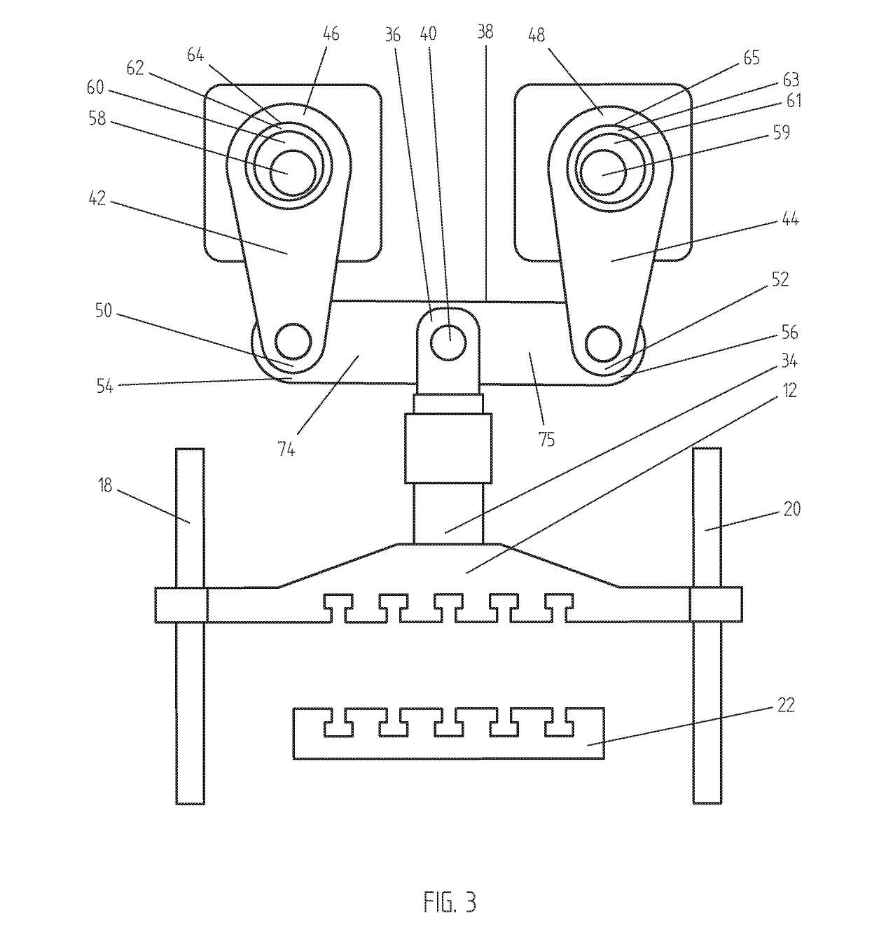

Referring to FIG. 1-3, a press machine 10 is shown including a movable member 12, such as, for example, a ram for a press machine, that generally moves along a vertical axis 14. The movable member 12 is positioned within frame 16. Frame 16 includes vertical guide posts 18, 20 for limiting movable member 12 to movement along vertical axis 14.

The press machine 10 includes a bed 22 that is connected to the frame 16.

A press drive assembly 24 includes at least one motor 70 and first 26 and second 28 crankshafts. In this embodiment, the at least one motor includes a pair of motors 70, 71 with one motor for rotating each crankshaft 26, 28 about its axis of rotation respectively. The at least one motor is preferably a servo motor. Alternatively, the at least one motor may be a conventional rotary motor. The at least one motor is operably connected to first 26 and second 28 crankshafts for driving thereby. In this embodiment a first motor 70 is fixedly connected to crankshaft 26 and a second motor 71 is fixedly connected to crankshaft 28 for rotationally driving thereby. Alternatively (not illustrated) said at least one motor may be operably connected to first and second crankshafts 26 and 28 thru a belt and pulley drive arrangement, a gear drive arrangement, or other crankshaft drive means for driving crankshafts 26 and 28.

A connection assembly 30 is provided to transmit movement between the crankshafts 26, 28 and the movable member 12. Although one connection assembly 30 is shown, multiple connection assemblies 30 could be provided along the axial length of the crankshafts 26, 28. The connection assembly, in the illustrated embodiment, comprises a pressing column 32 having a first end 34 fixedly connected to movable member 12 and a second end 36. The connection assembly further includes an averaging link 38 comprises a first portion 74 and a second portion 75, a first end 54, a second end 56, and a pivot point 40 located between said first 54 and second 56 ends. First portion 74 of averaging link 38 being that portion of averaging link 38 bounded by first end 54 and pivot point 40 and second portion 75 of averaging link 38 being that portion of averaging link 38 bounded by second end 56 and pivot point 40. The connection assembly further includes first 42 and second 44 connecting members having first ends 46, 48, respectively, and second ends 50, 52, respectively opposite thereto.

Pressing column 32 is pivotally connected to averaging link 38 at pivot point 40 thereof First 54 and second 56 ends of averaging link 38 are pivotally connected to second ends 50, 52 of connecting members 42, 44 respectively. The averaging link 38 functions to allow a weighted average of the two positions of the connecting members 42, 44 to control the stroke length of the movable member 12. In the preferred embodiment first and second portions of averaging link 38 are of equal length, that is pivot point 40 is midway between the pivotal connections at first 54 and second 56 ends of averaging link 38, and averaging link 38 functions to average (unweighted) the two positions of the connecting members 42, 42

Crankshaft 26 includes a cylindrical main portion 58 axially centered on the axis of rotation of crankshaft 26 and further includes at least one eccentric 60 rotatably fixed to crankshaft portion 58 or integrally formed therewith. Disposed about eccentric 60 is a bushing 62 disposed within a throughhole 64 in the first end 46 of connecting member 42. The rotation of the crankshafts 26 about the crankshaft axis causes the eccentric 60 to rotate thereby moving connecting member 42.

Similarly, crankshaft 28 includes a cylindrical main portion 59 axially centered on the axis of rotation of crankshaft 28 and further includes at least one eccentric 61 rotatably fixed to crankshaft portion 59 or integrally formed therewith. Disposed about eccentric 61 is a bushing 63 disposed within a throughhole 65 in the first end 48 of connecting member 44. The rotation of crankshaft 28 about the crankshaft axis causes the eccentric 61 to rotate thereby moving connecting member 44.

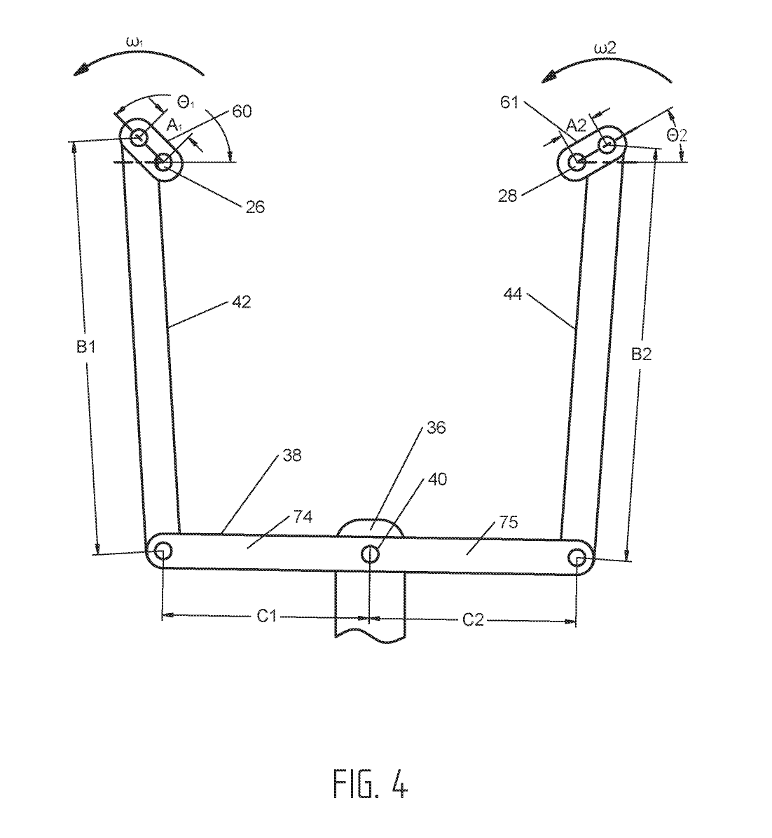

FIG. 4 is a simplified diagram of the primary moving elements of FIGS. 1-3. The angular position θ₁, of crankshaft 26, represents the angular measurement of a line drawn thru the center of crankshaft portion 58 and the center of eccentric 60 from the horizontal in a right hand rule coordinate system. The angular position θ₂, of crankshaft 28, represents the angular measurement of a line drawn thru the center of crankshaft 28 and the center of eccentric 61 from the horizontal in a right hand rule coordinate system. The eccentricity A₁ of eccentric 60, represents the measurement of the linear distance between the center of crankshaft portion 58 and the center of eccentric 60. The eccentricity A₂ of eccentric 61, represents the measurement of the linear distance between the center of crankshaft portion 59 and the center of eccentric 61.

In operation, crankshafts 26 and 28 are driven in either a first or second mode of operation wherein crankshafts 26 and 28 are synchronously rotated in either a same direction or in opposite directions respectively and with a phase offset corresponding to the angular position θ₂ of second crankshaft 28 at a time when the angular position θ₁ of crankshaft 26 is zero. When adjustment of the stroke length is desired, at least one of the motors, or at least one of the crankshaft drive means is adjusted so that the phase offset is varied thereby varying the stroke length of the press machine as will be explained in detail hereinbelow. In the preferred embodiment shown, at least one of the pair of motors is adjusted so that the crankshafts operate at a new phase offset. Both motors may be adjustable, or, alternatively, one motor may be adjustable and the other motor be non-adjustable.

The vertical position Y of pivot point 40, pressing column 32, and thus movable member 12 is a function of the angular positions θ₁ and θ₂ of crankshafts 26 and 28 respectively, the eccentricity A₁ and A₂ of eccentrics 60 and 61 respectively, the lengths B₁ and B₂ of connecting members 42 and 44, the lengths C₁ and C₂ of a first and second portions of averaging link 38 and the geometric relationship and positioning thereof. It will be obvious to one skilled in the art, that when the lengths B₁ and B₂ of connecting members 42 and 44 and the lengths C₁ and C₂ of the first and second portions of averaging link 38 are much greater than the eccentricity A₁ and A₂ of eccentrics 60 and 61, the vertical position Y of pivot point 40, pressing column 32, and thus movable member 12 can be approximated with the equation:

Y≈½A₁ Sin θ₁+½A₂ Sin θ₂ (Equation 1)

In a first and a second operational mode, crankshafts 26 and 28 are operated at angular velocities ω₁ and ω₂ respectively. If ω₁ and ω₂ are constant angular velocities, that is non-time varying, Equation 1 may be re-written:

Y(t)≈½A₁ Sin(ω₁t+θ_{1,0})+½A₂ Sin(ω₂t+θ_{2,0}) (Equation 2)

Where θ_{1,0} and θ_{2,0} represent the angular position of eccentrics 60 and 61 of crankshafts 26 and 28 respectively at an arbitrarily selected time zero.

In a first and second operational mode, further characterized in that eccentrics 60 and 61 of crankshafts 26 and 28 are of equal eccentricity, that is where A₁=A₂, and at a time where arbitrarily selected time zero is a time where the angular position of first crankshaft 26 is zero, that is where θ_{1,0}=0, Equation 2 may be re-written:

Y(t)≈½A₁ Sin(ω₁t)+½A₁ Sin(ω₂t+θ_{2,0,0}) (Equation 3)

where θ_{2,0,0} represents the angular position of eccentric 61 of crankshaft 28 at a point in time when the angular position of eccentric 60 of crankshaft 26 is zero (θ_{1,0}=0).

Equation 3 may be re-arranged to:

Y(t)≈½A₁(Sin(ω₁t)+Sin(ω₂t+θ_{2,0,0})) (Equation 4)

Using the trigonometric identity:

Sin(α)+Sin(β)=2 Sin ½(α+β)cos ½(α−β)

Equation 4 may be re-written:

Y(t)≈½A₁(2 Sin ½(ω₁t+ω₂t+θ_{2,0,0})cos ½(ω₁t−ω₂t−θ_{2,0,0})

Simplifying further:

Y(t)≈A₁(Sin ½(ω₁t+ω₂t+θ_{2,0,0})cos ½(ω₁t−ω₂t−θ_{2,0,0}) (Equation 5)

In a first operational mode, crankshafts 26 and 28 are rotated synchronously wherein their angular speeds are equal in magnitude, and wherein their rotational directions in the same direction, that is where ω₂=ω₁. Equation 5 may then be written:

Y(t)≈A₁(Sin ½(ω₁t+ω₁tθ_{2,0,0})Cos ½(ω₁t−ω₁t−θ_{2,0,0})

Simplifying and re-arranging:

Y(t)≈A₁ Cos ½(−θ_{2,0,0})(Sin ½(2ω₁t+θ_{2,0,0})

Appling trigonometric identity Cos(−α)=Cos(α), we obtain:

Y(t)≈A₁ Cos ½(θ_{2,0,0})(Sin ½(2ω₁t+θ_{2,0,0}) (Equation 6)

It can be seen from Equation 6, that when operated in a first operational mode, the position as a function of time of movable member 12, Y(t), is characterized as a sinusoidal wave (in this case a sine wave) whose stroke length is two times the amplitude of the motion of movable member 12 as described in the prior functions and is a function of the eccentricity A₁ of eccentrics 60, 61, and the angle θ₂ of second crankshaft 28 at a point in time when the angle θ₁ of first crankshaft 26 is zero, that is a phase offset (θ_{2,0,0}). It can be further seen from equation 6, that the stroke length of the press machine of the described invention can be infinitely varied between a maximum stroke length and a minimum stroke length by varying the phase offset. In the case of the preferred embodiment described, the maximum stroke length will be approximately two times the equal eccentricities A₁ and A₂ of eccentrics 60 and 61 respectively, when phase offset θ_{2,0,0} is equal to zero (0) degrees (eq. 6) and the minimum stroke length will be approximately zero when phase offset θ_{2,0,0} is equal to 180 degrees (eq. 6). In so far as phase offset θ_{2,0,0} may be varied infinitely between zero (0) and 180 degrees, the invention thus has the ability to provide a stroke length of infinite variability between a maximum and a minimum stroke length.

In a second operational mode, crankshafts 26 and 28 are rotated synchronously wherein their angular speeds are equal in magnitude, and wherein their rotational directions are in opposite directions, that is where, ω₂=−ω₁. Equation 5 may then be written:

Y(t)≈A₁(Sin ½(ω₁t−ω₁t+θ_{2,0,0})Cos ½(ω₁t+ω₁t−θ_{2,0,0})

Simplifying:

Y(t)≈A₁(Sin ½(θ_{2,0,0})Cos ½(2ω₁t−θ_{2,0,0}) (Equation 7)

It can be seen from Equation 7, that when operated in a second operational mode, the position as a function of time of movable member 12, Y(t), is characterized as a sinusoidal wave (in this case a cosine wave) whose stroke length is two times the amplitude of the motion of movable member 12 as described in the prior functions and is a function of the eccentricity A₁ of eccentrics 60, 61 angle θ₂ of second crankshaft 28 at a point in time when the angle θ₁ of first crankshaft 26 is zero, is a phase offset (θ_{2,0,0}). It can be further seen from equation 7, that the stroke length of the press machine of the described invention can be infinitely varied between a maximum stroke length and a minimum stroke length by varying the phase offset. In the case of the preferred embodiment described, the maximum stroke length will be approximately two times the eccentricity A₁ of eccentrics 60, 61, that is when phase offset θ_{2,0,0} is equal to 180 degrees (eq. 7) and the minimum stroke length will be approximately zero, that is when phase offset θ_{2,0,0} is equal to zero (0) degrees (eq. 7). In so far as phase offset θ_{2,0,0} may be varied infinitely between zero (0) and 180 degrees, the invention thus has the ability to provide a stroke length of infinite variability between a maximum and a minimum stroke length.

In the preferred embodiment and for the sole purpose of simplifying the mathematics, many geometric conditions were described. These include but are not limited to, eccentricities A1 and A2 of eccentrics 60 and 61 of crankshafts 26 and 28 are equal, lengths C1 and C2 of first 74 and second 75 portions of averaging link 38 are equal, lengths B1 and B2 of connecting members 42 and 44 are equal, and lengths B1 and B2 of connecting members 42 and 44 and lengths C1 and C2 of first 74 and second 75 portions of averaging link 38 are much greater than the eccentricities A1 and A2 of eccentrics 60 and 61. It will be obvious then to one skilled in the art, that if the above conditions and/or others are different the functions describing the position Y(t) as a function of time of movable member 12, will yet be characterized in that the stroke length of the press machine of the current invention is a function of the eccentricities of eccentrics 60 and 61 of crankshafts 26 and 28 respectively and the phase offset between said crankshafts.

It will be further obvious to one skilled in the art, that the angular velocities of crankshafts 26 and 28 need not be constant over time, but rather, may be time varying. It is however advantageous that the respective angular velocities be synchronous. That is, as a function of time, the rotational speed of crankshaft 26 and the rotation speed of crankshaft 28 be of equal magnitude and one of either the same direction or of opposite directions. Said rotational speeds of crankshafts 26 and 28 may be constant over time or time varying.

Although the invention has been described in terms of the embodiment of a press machine, the invention is not limited to press machines and is applicable to other operations wherein the adjustability of stroke length is desirable such as compressors and V8 engines.

The invention has been described in terms of two synchronized motors having the ability to operate the two crankshafts out of phase with one another. The use of two motors allows the use of two half-sized motors to be used. The invention, however, is not limited to two motors and may be applicable more than two motors or a single motor as long as the arrangement allows the adjustability of operating one crankshaft out of phase with the other crankshaft.

The invention has been described in terms of the illustrated connection assembly between the drive assembly and the movable member. The invention, however, is not limited to the illustrated connection assembly and may use a connection assembly having multiple links and/or connection points to the movable member such as the connection assemblies shown and described in U.S. Pat. Nos. 5,823,087 and 6,055,903, the disclosures of which are incorporated by reference herein.

One of ordinary skill in the art, in light of the teachings herein, can generate additional embodiments and modifications without departing from the spirit of, or exceeding the scope of, the invention.

Nothing in the above description is meant to limit the invention to any specific materials, geometry, or orientation of elements. Many parts/orientation substitutions are contemplated within the scope of the invention and will be apparent to those skilled in the art. The embodiments described herein were presented by way of example only and should not be used to limit the scope of the invention.

What is claimed is:

1. An apparatus comprising:
a first crankshaft configured to rotate at a first angular velocity;
said first crankshaft fixedly connected to a first eccentric having a first eccentricity;
a second crankshaft configured to rotate at a second angular velocity;
said second crankshaft fixedly connected to a second eccentric having a second eccentricity;
said second crankshaft configured to operate with said first crankshaft with a phase offset;
a movable member configured to move along a vertical axis through a stroke length;
a connection assembly operably connected to said first and second eccentrics and said movable member;
said connection assembly configured to convert rotary motion of said first and second crankshafts connected to said first and second eccentrics into linear motion of said movable member along a vertical axis through said stroke length such that said stroke length can be varied by adjusting said phase offset.

2. The apparatus of claim 1 wherein said first crankshaft is operably connected to and rotated by a first motor and said second crankshaft is operably connected to and rotated by said first motor.

3. The apparatus of claim 1 wherein said first crankshaft is operably connected to and rotated by a first motor and said second crankshaft is operably connected to and rotated by a second motor.

4. The apparatus of claim 1 wherein said connection assembly is configured such that said stroke length moved by said movable member can be infinitely varied between a maximum stroke length and a minimum stroke length.

5. The apparatus of claim 1 wherein said connection assembly comprises:
a first connecting member operably connected to said first eccentric;
a second connecting member operably connected to said second eccentric;
an averaging link have a first end and a second end;
said first connecting member operably connected to said first end of said averaging link;
said second connecting member operably connected to said second end of said averaging link;
said movable member connected to said averaging link at a connecting position on said averaging link between said first end and said second end of said averaging link.

6. The apparatus of claim 5 wherein:
the distance between said first end of said averaging link and said connecting position on said averaging link is equal to the distance between said second end of said averaging link and said connecting position on said averaging link.

7. The apparatus of claim 6 configured such that a vertical position of said movable member along said vertical axis can be approximated by the sum of:
one-half the product of said first eccentricity of said first eccentric and the sine of the sum of a first angular position of said first crankshaft; and
one-half the product of said second eccentricity of said second eccentric and the sine of the sum of a second angular position of said crankshaft.;

8. The apparatus of claim 6 wherein:
said first and second connecting members of equal in length.

9. The apparatus of claim 8 configured such that a vertical position of said movable member along said vertical axis at a given time can be approximated by the sum of:
one-half the product of said first eccentricity of said first eccentric and the sine of the sum of a first angular position of said first eccentric at said given time and the product of the first angular velocity of said first crankshaft at said given time and said given time; and
one-half the product of said second eccentricity of said second eccentric and the sine of the sum of a second angular position of said second eccentric at said given time and the product of the second angular velocity of said second crankshaft at said given time and said given time;
wherein said first angular velocity of said first crankshaft and said second angular velocity of said second crankshaft are constant and do not vary over time.

10. The apparatus of claim 1 wherein:
said first crankshaft is configured to rotate in the same direction as said second crankshaft.

11. The apparatus of claim 10 wherein:
said first crankshaft is configured to rotate at a first angular velocity that is constant over time and equal in magnitude to said second angular velocity of said second crankshaft.

12. The apparatus of claim 1 wherein:
said first crankshaft is configured to rotate in a direction opposite to the direction that said second crankshaft is configured to rotate.

13. The apparatus of claim 12 wherein:
said first crankshaft is configured to rotate at said first angular velocity that is constant over time and equal in magnitude to said second angular velocity of said second crankshaft.

14. A method for controlling the position of a movable member comprising the steps of:
rotating a first crankshaft fixedly connected to a first eccentric operably connected to a connection assembly configured to drive said movable member along a vertical axis a stroke length;
rotating a second crankshaft fixedly connected to a second eccentric operably connected to a connection assembly configured to drive said movable member along a vertical axis said stroke length of said movable member;
adjusting said stroke length by adjusting a phase offset between said first crankshaft and said second crankshaft.

15. The method of claim 14 wherein said first crankshaft is operably connected to and rotated by a first motor and said second crankshaft is operably connected to and rotated by said first motor.

16. The method of claim 14 wherein said first crankshaft is operably connected to and rotated by a first motor and said second crankshaft is operably connected to and rotated by a second motor.

17. The method of claim 14 wherein said movable member can be driven a stroke length infinitely variable between a maximum stroke length and a minimum stroke length.

18. The method of claim 14 further comprising the steps of:
rotating said first crankshaft at a first angular velocity and in the same direction said second crankshaft is rotated.

19. The method of claim 18 further comprising the steps of:
rotating said second crankshaft at a second angular velocity equal in magnitude to said first angular velocity.

20. The method of claim 14 wherein further comprising the steps of:
rotating said first crankshaft at a first angular velocity and in a direction opposite said second crankshaft is rotated;

21. The apparatus of claim 20 wherein further comprising the steps of:
rotating said second crankshaft at a second angular velocity equal in magnitude to said first angular velocity of said first crankshaft.
